(19) United States
(12) Patent Application Publication
(10) Pub. No.: US 2006/0098633 A1
(43) Pub. Date: May 11, 2006

(54) Switching apparatus for providing MMS in PSTN and method thereof

(75) Inventor: Yong-Hyun Kim, Gyeonggi-Do (KR)

Correspondence Address: FLESHNER & KIM, LLP, P.O. BOX 221200, CHANTILLY, VA, 20153, US

(73) Assignee: LG Electronics Inc.

(21) Appl. No.: 11/269,655

(22) Filed: Nov. 9, 2005

(30) Foreign Application Priority Data
Nov. 10, 2004 (KR) 2004-0091228

(51) Int. Cl. H04L 12/66; H04L 12/56

(52) U.S. Cl. 370/352; 370/401

(57) ABSTRACT

A switching method and apparatus provides MMS service in a PSTN. The apparatus includes a first interface board for checking signals received from an analog exterior line for connection to an SMS server and an MMS server, and a second interface board for receiving and storing SMS data and MMS data by being connected to the SMS server and the MMS server using a checked signal. The second interface board may be used as common resources of the system, thereby providing MMS service using one MMS interface, not individual MMS interfaces, for an SLT exterior line and an SLT interior line.

### BACKGROUND OF THE INVENTION

1. Field of the Invention

The present invention relates to a public switched telephone network (PSTN), and more particularly to a switching method and apparatus for providing a multimedia messaging service (MMS) in a PSTN.

2. Description of the Conventional Art

A multimedia messaging service (MMS) is a service for transmitting/receiving a rich media message that includes a combination of a text message, music, an image, a moving image, etc. In using such a service, a user will transmit an MMS message containing multimedia data to another party's mobile communication terminal, or to another party's E-mail address.

FIG. 1 shows a system for providing MMS service in a general mobile communication network. This system comprises a message storing unit 102 for storing a multimedia message, an MMS server 104 for controlling input/output of the stored message, an MMS replay 106 for transmitting a message between different message systems, and a user database 108 for storing signature, environment, and ID information of a user who exchanges the message.

In addition, the system includes a second generation (26) mobile network 110, a third generation (36) mobile network 112, a mobile network 114, and an Internet 116. The Internet exchanges data with the MMS replay 106, a wired E-mail client 120 for transmitting/receiving E-mail by wire, a mail box 118 for storing the transmitted/received E-mail. The Internet, and/or other elements of this system, also exchanges data with MMS user equipment 122, 124, 126, and 128 which are connected to the several networks 110, 112, 114, and 116 for transmitting/receiving data.

However, the related-art MMS system is not connected to a public switched telephone network (PSTN), and thus does not provide MMS service to or through PSTNs.

### BRIEF DESCRIPTION OF THE INVENTION

An object of the invention is to solve at least the above problems and/or disadvantages and to provide at least the advantages described hereinafter.

Another object of the present invention is to provide a switching method and apparatus which provides an MMS service in a PSTN switching system, and which preferably shares the MMS in a plurality of analog exterior and interior lines as common resources.

These and other objects and advantages of the present invention are achieved through a switching apparatus for providing an MMS in a PSTN, comprising: an analog exterior line interface board for detecting a ring signal through an analog exterior line; an MMS interface board for receiving and storing SMS data and MMS data by being connected to an external SMS server and an external MMS server by using an ID received through a channel of the ring signal; and a central control board for controlling a system in order to transmit the stored MMS data into an interior line terminal.

In accordance with another embodiment, a method for providing an MMS in a PSTN, comprises: detecting a ring signal through an analog exterior line; connecting an MMS interface board to an external SMS server and an external MMS server by using an ID received through a channel of the ring signal and thereby receiving and storing SMS data and MMS data; controlling the system in order to transmit the stored MMS data into an interior line terminal; and transmitting the stored MMS data into the interior line terminal.

In any one or more of the foregoing embodiments, a modem & SMS interface of the MMS interface board may certify an ID input through an analog exterior line for connection to an SMS server. A connection to the SMS server may then be established. Also, the modem & SMS interface may perform a connection to the MMS server to thereby receive MMS data. The MMS data may then be stored in a local storing unit. Also, the central control board may comprise a PCM switch for switching a PCM bus.

### BRIEF DESCRIPTION OF THE DRAWINGS

FIG. 1 is a diagram showing a system for providing MMS service in a related-art mobile communication network.

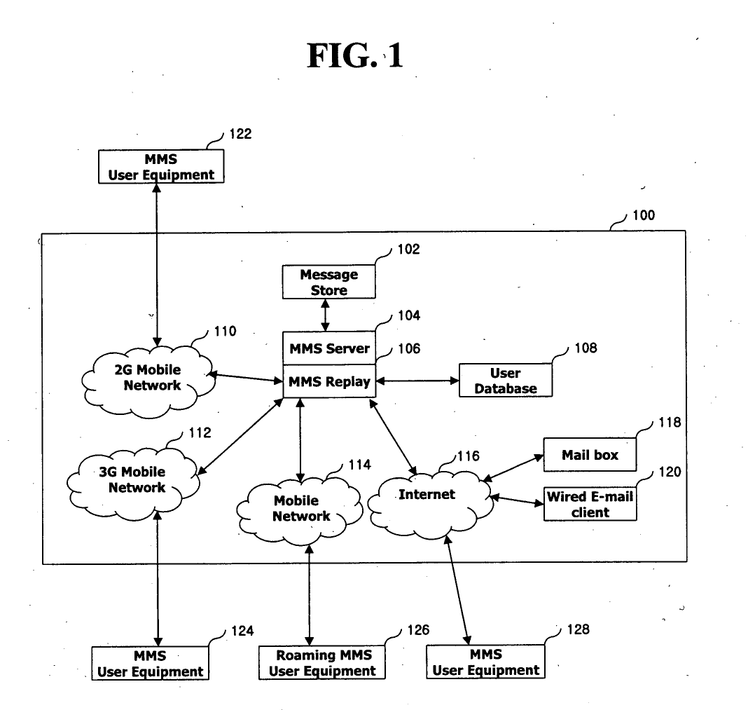

FIG. 2 is a diagram showing a switching apparatus for providing an MMS service in a PSTN according to one embodiment of the present invention.

FIG. 3 is a flowchart showing steps included in a method for providing MMS service in a PSTN according to one embodiment of the present invention.

### DETAILED DESCRIPTION OF INVENTION

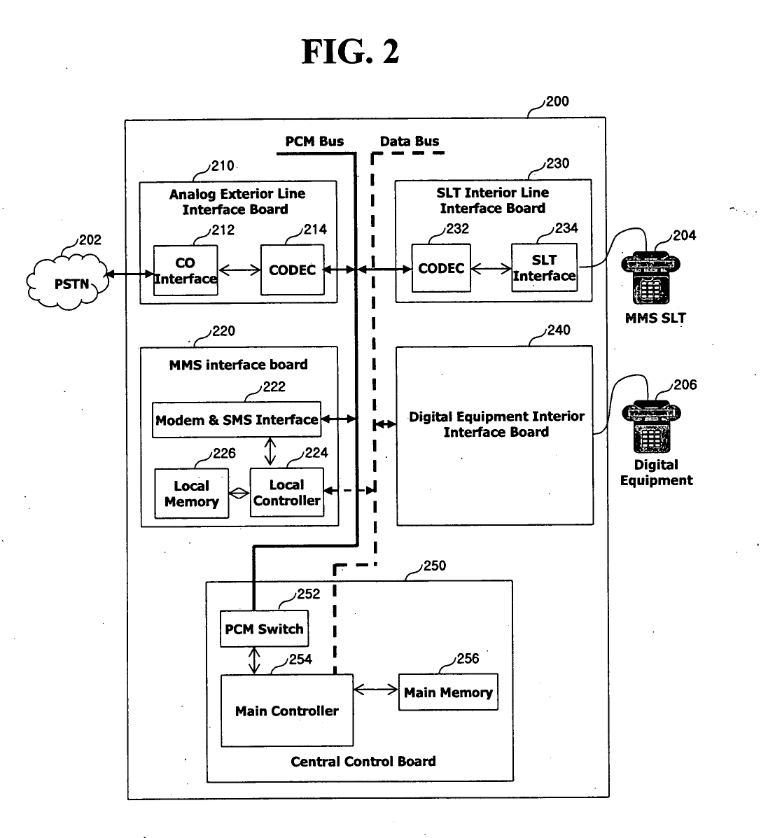

FIG. 2 shows a switching apparatus for providing MMS service in a PSTN according to the one embodiment of the present invention. The apparatus includes an analog exterior line interface board 210, an MMS interface board 220, an SLT interior line interface board 230, and a central control board 250. The analog exterior line interface board serves as an interface with a PSTN.

The MMS interface board 220 receives and stores SMS data and MMS data by being selectively connected to an exterior SMS server and an exterior MMS server through the analog exterior line interface board 210. The SLT interior line interface board 230 transmits the MMS data stored in the MMS Interface board 220 to a single line telephone (SLT) 204 that supports a multimedia messaging service (MMS), which will be hereinafter referred to as MMS SLT 204. And, the central control board 250 controls the entire system in order to provide the MMS data. The MMS SLT 204 replays the MMS data output through the SLT interior line interface board 230.

The analog exterior line interface board 210 includes a central office interface 212 for forming a loop with a PSTN 202, and a first codec 214 for converting an analog signal input from the PSTN into a digital signal based on a PCM method.

The MMS Interface board 220 includes a modem & SMS interface 222 for analyzing a caller ID, a frequency shift keying (FSK) signal of an SMS, and an analog modem signal respectively received through a PCM bus. Board 220 also includes a local memory 226 for storing the analyzed data, and a local controller 224 for controlling the MMS interface board.

The SLT interior line interface board 230 includes a second codec 232 for converting PCM data into an analog signal, and an SLT interface 234 for transmitting the converted signal into the MMS SLT.

The central control board 250 includes a PCM switch 252 for switching PCM channels of the analog exterior line interface board 210, the MMS interface board 220, and the SLT interior line interface board 230, a main memory 256 for storing data to be transmitted/received by switching the PCM channels, and a main controller 254 for controlling the entire system.

In operation, the central control board 250 detects a ring (or a line reversal) input from the PSTN 202 through the analog exterior line interface board 210, and then PCM-switches a channel of the detected ring with the MMS interface board 220 to thereby connect the analog exterior line interface board to the MMS interface board through a PCM bus. When the two boards are connected to each other, the first codec 214 of the analog exterior line interface board 210 converts the caller ID (CID) received from the PSTN as an analog signal, the frequency shift keying signal of the SMS, and the analog modem signals into digital signals. The signals, which have been converted into digital signals through the PCM bus that connects the two boards, are transmitted to the modem & SMS interface 222 of the MMS interface board 220.

The modem & SMS interface 222 analyzes the CID signal input after being converted into a digital signal based on a PCM method, certifies an ID for connecting to an SMS server (not shown), that is, an SMS server ID, and then stores the SMS server ID into the local memory 226. If the SMS server ID is certified, the modem & SMS interface performs a connection to the SMS server by the local controller 224, receives information required to receive MMS data, and stores the information into the local memory 226.

Then, the local controller 224 analyzes the stored information, performs a PPP-connection to the MMS server of the PSTN through the modem & SMS interface 222 to thereby receive MMS data, and then stores the received MMS data into the local memory 226. If the received MMS data has been stored in the local memory 226, the main controller 254 of the central control board 250 judges whether a receiving terminal is the MMS SLT 204 or digital equipment 206.

As a result of the identification, if the receiving terminal is the MMS SLT 204, the main controller 254 connects the MMS interface board 220 to the SLT interior line interface board 230 through the PCM bus by the PCM switch 252. When the two boards are connected to each other, the local controller 224 transmits the CID stored in the local memory 226 to the second codec 232 of the SLT interior line interface board 230.

Also, when an SMS connection between the MMS SLT 204 and the modem & SMS interface 222 is performed through the CID, information required to receive MMS data is transmitted to the SLT interior line interface board 230. Then, when the transmission of the information is completed, the SMS connection is released.

When the modem & SMS interface 222 and the MMS SLT are PPP-connected to each other through the information, the MMS data stored in the local memory 226 is transmitted to the MMS SLT. Then, when transmission of the MMS data is completed, the PPP-connection is released.

If the receiving terminal is digital equipment 206, the main controller 254 stores the MMS data stored in the local memory 226 into the main memory 256 of the central control board 250. The stored MMD data is transmitted to digital equipment 206 through a digital equipment interior interface board 240 by the main controller 254.

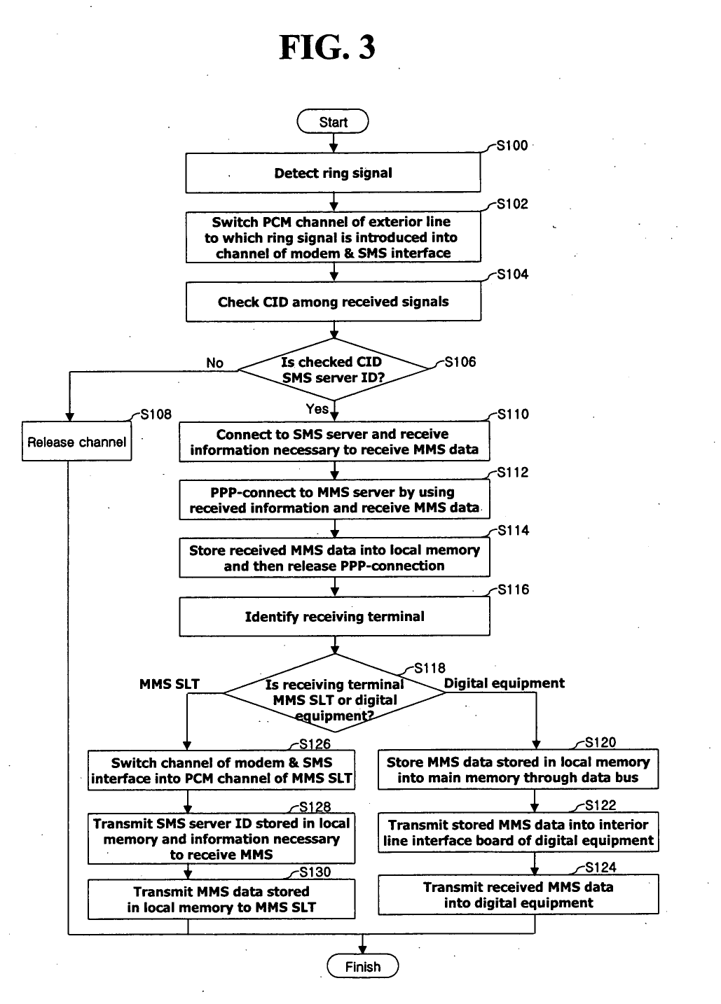

FIG. 3 is a flowchart showing steps included in a method for providing MMS service in a PSTN according to one embodiment of the present invention. According to this embodiment, when the switching system detects a ring signal (for example, a ring or a line reversal) through an analog exterior line, the PCM switch 252 of the switching system switches a PCM channel of the analog exterior line into which the ring signal is input into a channel of the modem & SMS interface by the main controller 254 (S100, S102). When the switching has been performed, the CID, the FSK signal of the SMS, and the analog modem signals received through the switched channel are transmitted to the modem & SMS interface.

Then, the modem & SMS interface 222 checks the CID among the received signals (S104). When the checked CID is not an ID for connection to an SMS server, that is, an SMS ID, the PCM channel of the analog exterior line and the PCM channel of the modem & SMS interface are released (S106, S108).

On the contrary, when the checked CID is an ID for connection to an SMS server, that is, an SMS ID, the MMS interface board performs a connection to the SMS server by the local controller 224 to thereby receive information necessary to receive MMS data (S106, S110). If the information reception has been completed, the local controller 224 releases the connection between the MMS interface board and the SMS server, analyzes the received information, and then performs a PPP-connection to the MMS server to thereby receive substantial MMS data (S112). The local controller 224 stores the received MMS data into the local memory 226. Also, when the MMS data storage is completed, the local controller 224 releases the PPP-connection with the MMS server (S114).

When the PPP-connection is released, the main controller 254 releases the PCM channel of the exterior line and the PCM channel of the modem & SMS interface and identifies whether a receiving terminal is an MMS SLT or a digital equipment (S116).

As a result of the identification, if the receiving terminal is not the MMS SLT, that is, the receiving terminal is digital equipment 206, the main controller 254 stores the MMS data stored in the local memory 226 into the main memory 256 through a data bus (S118, S120). The stored MMS data is transmitted to the digital equipment interior interface board 240 by the main controller 254, and the digital equipment interior interface board 240 transmits the data to the digital equipment (S122, S124).

However, if the receiving terminal is an MMS SLT 204, the main controller 254 switches the PCM channel of the modem & SMS interface into a PCM channel of the MMS SLT (S126). When the switching is completed, the local controller 224 transmits an ID for connecting to the SMS server stored in the local memory, that is, an SMS server ID to an SLT interior line interface board 230 through the switched PCM channel. Then, when an SMS-connection between the MMS SLT and the modem & SMS interface is performed, the local controller 224 transmits information necessary to receive an MMS to the SLT interface board 230 and releases the SMS connection when the transmission is completed (S128).

Then, when the MMS SLT is PPP-connected to the modem & SMS interface by the transmitted information, the local controller 224 transmits the MMS data stored in the local memory to the MMS SLT. When the transmission of the MMS data is completed, the local controller 224 releases the PPP connection and releases the PCM channel of the MMS SLT and the PCM channel of the modem & SMS interface (S130).

In summary, a switching method and apparatus provides an MMS service in a PSTN. This is accomplished using an MMS interface board which performs a PPP-connection to the MMS server of the PSTN, to thereby receive MMS data. The received MMS data is transmitted to the MMS SLT connected to the SLT interface board, thereby providing an MMS even in the PSTN.

Also, the MMS interface board is preferably used as common resources of the system, to thereby provide an MMS by one MMS interface not by individual MMS interfaces for an SLT exterior line and an SLT interior line. The MMS service can be provided to plural analog exterior/inner line terminals, which number more than the number of the MMS interfaces.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A switching apparatus for providing an MMS service comprising:
a first interface board which detects a ring signal through an analog exterior line coupled to a PSTN;
a second interface board which stores SMS data and MMS data, the second board being connected to an external SMS server and an external MMS server using identification information received through a channel of the ring signal; and
a central control board which controls transmission of the stored MMS data into an interior line terminal.

2. The apparatus of claim 1, further comprising:
an SLT interior line interface board for transmitting the stored MMS data into the interior line terminal.

3. The apparatus of claim 1, wherein the identification information includes an ID for connection to an SMS server.

4. The apparatus of claim 1, wherein the first interface board comprises:
a central office interface which detects a ring signal transmitted from the PSTN by forming a loop; and
a first codec which converts analog signals, received through a channel of the ring signal for connection to the SMS server, into digital signals based on a PCM method.

5. The apparatus of claim 3, wherein the identification information for connection to the SMS server includes a caller ID.

6. The apparatus of claim 4, wherein the first codec transmits the converted signals to the MMS interface board through a PCM bus.

7. The apparatus of claim 1, wherein the second interface board comprises:
a modem & SMS interface which checks an ID for connecting to the SMS server;
a local storing unit which performs a connection to the SMS server using the checked ID and then storing information received from the SMS server; and
a local controller which controls the MMS interface board.

8. The apparatus of claim 7, wherein the modem & SMS interface establishes a connection to the SMS server using the checked ID.

9. The apparatus of claim 7, wherein the modem & SMS interface establishes a connection to the MMS server using the received information.

10. The apparatus of claim 7, wherein the modem & SMS interface establishes a connection to the SMS server to thereby receive information for receiving MMS data, and then stores the information in the local storing unit.

11. The apparatus of claim 10, wherein the modem & SMS interface establishes a connection to the MMS server using the stored information and then receives MMS data.

12. The apparatus of claim 4, wherein the converted digital signals are transmitted to the MMS interface board through a PCM bus.

13. The apparatus of claim 1, wherein the central control board comprises:
a PCM switch which switches a PCM bus of boards;
a main storing unit which stores data transmitted/received or to be transmitted/received through the switched PCM bus; and
a main controller.

14. The apparatus of claim 13, further comprising:
an MMS interface board, and an SLT interior line interface board coupled between the first board and an MMS SLT.

15. The apparatus of claim 13, wherein the main controller transmits data stored in the second interface board into an SLT interior line interface board by controlling a local controller.

16. The apparatus of claim 2, wherein the SLT interior line interface board comprises:
a second codec which converts a digital signal received from the MMS interface board into an analog signal; and
an SLT interface which transmits the converted signal into the interior line terminal.

17. The apparatus of claim 1, wherein the interior line terminal comprises an MMS SLT.

18. The apparatus of claim 1, wherein the ring signal comprises a ring or a line reversal.

19. The apparatus of claim 1, wherein the system switches the SMS data and the MMS data.

20. A method for providing an MMS service, comprising:
detecting a ring signal through an analog exterior line coupled to a PSTN;
connecting a system to an external SMS server and an external MMS server using an ID received through a channel of the ring signal, and receiving and storing SMS data and MMS data;
controlling the system in order to transmit the stored MMS data into an interior line terminal; and
transmitting the stored MMS data into the interior line terminal.

21. The method of claim 20, wherein the ID includes an ID for connection to the SMS server.

22. The method of claim 21, wherein the ID for connection to the SMS server comprises a caller ID.

23. The method of claim 20, wherein receiving and storing SMS data and MMS data comprises:
connecting an MMS interface board to the SMS server using the ID;
receiving information for receiving MMS data from the connected SMS server; and
connecting the MMS interface board to the MMS server using the information and thereby receiving and storing the MMS data.

24. The method of claim 20, wherein receiving and storing SMS data and MMS data further comprises:
converting the ID received through the channel of the ring signal into a digital signal; and
transmitting the digital signal to an MMS interface board through a PCM bus.

25. The method of claim 20, wherein controlling the system comprises:
storing data transmitted/received or to be transmitted/received through a switched PCM bus; and
transmitting the stored data to a corresponding board.

26. The method of claim 25, wherein the system comprises:
an analog exterior line interface board, an MMS interface board, and an SLT interior line interface board coupled to the PCM bus.

27. The method of claim 20, wherein transmitting the stored MMS data into the interior line terminal comprises:
converting a digital signal received from the MMS interface board into an analog signal; and
transmitting the converted analog signal to the interior line terminal.

28. The method of claim 20, wherein the interior line terminal comprises an MMS SLT.

29. The method of claim 20, wherein the system switches the SMS data and the MMS data.
